(19) United States
(12) Patent Application Publication
(10) Pub. No.: US 2002/0020545 A1
(43) Pub. Date: Feb. 21, 2002

(54) Shielded flat cable, manufacturing method therefor and machining apparatus therefor

(75) Inventor: Toshiaki Suzuki, Nagoya-shi (JP)

Correspondence Address: Oliff & Berridge PLC, P.O. Box 19928, Alexandria, VA, 22320, US

(73) Assignee: AUTONETWORKS TECHNOLOGIES, LTD., SUMITOMO WIRING SYSTEMS, LTD., SUMITOMO ELECTRIC INDUSTRIES, LTD

(21) Appl. No.: 09/733,933

(22) Filed: Dec. 12, 2000

(30) Foreign Application Priority Data
Dec. 14, 1999 (JP) JP HEI 11-354282
Aug. 31, 1999 (JP) JP HEI 11-244209

(51) Int. Cl. H01B 11/02

(52) U.S. Cl. 174/117 F

(57) ABSTRACT

A flat cable 10 is constituted by integrally forming a shield 20 and an external sheath 24 with a plurality of core wires 12 and 18. Then, a slit S for branching each of the core wires 12 and 18 is formed at a terminal of the flat cable 10. Further, a coupling portion 26 is formed at a part P in which this slit S is formed. The coupling portion 26 is a means for mechanically coupling the shield 20 thereto. Preferably, the coupling portion 26 is constituted by an external sheath 24 for riveting the shield 20 thereto by penetrating the shield 20 and then connecting the shield 20 thereto.

### BACKGROUND OF THE INVENTION

1. Field of the Invention

The present invention generally relates to a shielded flat cable and, more particularly, to a shielded flat cable having a shield formed in such a manner as to integrally cover a plurality of electric wires, and to a method of manufacturing thereof, and to a machining apparatus therefor.

2. Description of the Related Art

For example, a shielded flat cable of the aforementioned type illustrated in FIG. 24 has been developed. This shielded flat cable is constructed so that a plurality of coated wires 52, each of which is obtained by coating a conductor 54 with an insulator 56, and a plurality of drain wires 58 constituted only by conductors are arranged on the same plane in parallel with one another, that these wires 52 and 58 (hereunder, these wires 52 and 58 will be referred to generically as “core wires”) are covered with a shield 60, which is conducted only to the drain wires 58, and that the shield 60 is covered with an insulative external sheath 64.

In such a shielded flat cable 50, the shield 60 is formed by usually bonding a pair of metallic foils 62a and 62b, which sandwich the core wires 52 and 58 from both sides thereof, to each other with an adhesive, as illustrated in this figure.

In the aforementioned shielded flat cable 50, the core wires 52 and 58 are integrated with one another by using the shield 60 and the external sheath 64. Thus, the distance D between the adjacent core wires cannot be changed. Therefore, in the case of some wiring manner, there is the need for forming a slit 61 between the adjacent core wires 52 and 58 to thereby enable the change of the distance therebetween.

FIG. 25 is a perspective diagram illustrating a state in which the branching slits 61 are formed in the shielded flat cable 50 shown in FIG. 24. The distance D between the adjacent core wires 52 and 58 can be changed by forming the slits 61 as illustrated in FIG. 25. Thus, for instance, specific wires can be inserted into cavities formed at certain intervals.

However, in the case of the aforementioned shield flat cable 50, the distance between the adjacent core wires 52 and 58 is very narrow. Thus, when the slits 61 are formed, an area of bonded portion of the metallic foils 62a and 62b is decreased. This results in decrease in the adhesive strength of parts, in each of which the slit 61 is provided, of the cable. Thus, as illustrated in FIG. 25, an exfoliation is liable to occur in each of the bonded portion of the metallic foils 62a and 62b. Consequently, this conventional shielded flat cable has a problem that the shielding performance is degraded owing to the exfoliation of the metallic foils 62a and 62b. Further, the electrostatic capacity formed between the conductor 54 and the shield 60, which has been maintained at a constant level, varies owing to the exfoliation of the metallic foils 62a and 62b. This causes a problem that uniformity of impedance in the longitudinal direction of a transmission path formed from the conductor 54 and the shield 60 is degraded, and that what is called a reflection phenomenon occurs, that is, a precedently transmitted signal acts as a noise and affects a subsequently transmitted signal.

The present invention is accomplished to solve the problems of the conventional art. Accordingly, an object of the present invention is to provide a shielded flat cable, which can prevent a shield from peeling off conductors even in the case of branching a terminal thereof and thus can suitably maintain the shielding performance thereof, and to provide a method of manufacturing such a shielded flat cable.

### SUMMARY OF THE INVENTION

To solve the problems, according to an aspect of the present invention, there is provided a shielded flat cable, which includes a plurality of core wires arranged in parallel with one another on the same plane, a shield having a pair of metallic foils sandwiching each of the core wires in front and rear directions perpendicular to the plane, and an external sheath coating an outer circumference of the shield. This cable comprises a slit selectively formed between the core wires to branch a terminal of each of the core wires, and a coupling portion formed at least at a part defining the slit to maintain both the metallic foils of the shield in a coupled state.

According to this aspect of the present invention, the terminal of each of the core wires is branched by the slit. Thus, the core wires can be suitably connected to cavities provided at different intervals. In addition, the coupling portion for maintaining both the metallic foils of the shield in the coupled state is formed at least at a part, in which the slit is formed, of the layered product having the shield and the external sheath. Thus, this coupling portion reinforces the coupling between the metallic foils of the shield. Incidentally, the word “selectively” means that a given number of slits may be formed at an arbitrary place. Thus, the slit may be provided between each of all pairs of adjacent ones of the core wires.

Especially, it is preferable that a plurality of the coupling portions are formed along the longitudinal direction of the slit.

Thus, the coupling force of the shield at the slit portion is enhanced in proportion to the number of the formed coupling portions.

The coupling portions may be constituted by welding the metallic foils.

Thus, in the case of the cable of the present invention, the shield itself is coupled to the metallic foils by a large coupling force.

On the other hand, the coupling portion may be adapted to connect the front and rear sides of the external sheath to each other through a through hole formed in the shield.

Thus, the metallic foils are securely tightened together by the external sheaths at the bonded portion thereof. That is, the external sheaths provided at the front and rear sides thereof are connected to each other by the external sheath penetrating through the thorough hole. Thus, the bonded portion is restrained by the external sheath from both sides. Consequently, as compared with the conventional shield structure in which the metallic foils are simply bonded with an adhesive, a large coupling force acts between the metallic foils. Moreover, the coupling portion can be constructed only by forming the through hole in the shield without increasing the number of components.

In this case, preferably, the external sheath is a resin molded on an outer periphery of the shield in such a manner as to fill the through hole.

Thus, when the external sheath is formed, the material of the external sheath gets into the through hole, so that the shield is, as it were, riveted.

It is preferable that especially, a peripheral edge portion of the thorough hole is formed so that one of the metallic foils is folded back in such a manner as to be supported and surrounded by the other of the metallic foils.

Thus, the metallic foils of the shield are coupled to each other in a state in which the foils engage with each other. Consequently, the coupling force of the shield is increased still more.

Additionally, it is preferable that the shield is constituted by metallic foils stuck to each other.

Thus, a sticking force acts on both the metallic foils of the shield. Consequently, the coupling force of the shield is increased still more.

Moreover, preferably, the through hole is formed by being elongated in the longitudinal direction of the slit.

Thus, high sealing properties can be obtained at the slit portion in a state in which the width thereof is limited to a small value. Conversely, the proportion of the connected portion increases. Thus, a more large coupling force can be obtained. The elongated through holes are shaped like, for example, an oval or ellipse, or an ovoid.

In the case of another embodiment of the present invention, preferably, the coupling portion continuously extends along the longitudinal direction of the slit.

Thus, the length of the coupling portion increases. The coupling force is enhanced for that.

Further, preferably, the coupling portion is continuously constituted at a part of the external sheath.

To form the slit continuously extending in the longitudinal direction thereof in this way, it is sufficient that a part of the external sheath is welded by, for instance, thermal welding, and that the coupling portion is constituted by coating the shield with such a welded portion. Thus, the coupling portion can be constructed without adding special components thereto. Consequently, desired adhesiveness can be obtained.

According to another aspect of the present invention, there is provided a shielded flat cable machining apparatus for machining an intermediate product having a plurality of core wires arranged in parallel with one another on the same plane, a shield having a pair of metallic foils sandwiching each of the core wires in front and rear directions perpendicular to the plane and coating each of the core wires, an external sheath coating an outer circumference of the shield, and a slit formed in a layered product having the external sheath and the shield, the slit branching a terminal of each of the core wires, and the shielded flat cable machining apparatus for forming a coupling portion maintaining the metallic foils of the shield in a coupled state, at a part where the slit is defined. This shield flat cable machining apparatus comprises a pair of heating/pinching elements enabled to pinch a branched terminal portion of the intermediate product so as to melt slit portions of the intermediate product, pinching surfaces each formed on the heating/pinching elements and defining a plurality of grooves corresponding to the core wires included in the branched terminal portion, and partitioning elements each disposed between adjacent ones of the plurality of grooves to be put into the slit when the branched terminal portion is pinched. In this apparatus, a face for enlarging the slit is formed in each of the grooves so that a gap is formed between a corresponding one of the core wires and a corresponding one of the partitioning elements when the intermediate product is pinched.

Further, according to another aspect of the present invention, there is provided a shielded flat cable manufacturing method having the steps of machining an intermediate product having a plurality of core wires arranged in parallel with one another on the same plane, a shield having a pair of metallic foils sandwiching each of the core wires in front and rear directions perpendicular to the plane and coating each of the core wires, an external sheath coating an outer circumference of the shield, and a slit formed in a layered product having the external sheath and the shield, the slit branching a terminal of each of the core wires, and forming a coupling portion maintaining the metallic foils of the shield in a coupled state, at a part where the slit is defined. In this method, the step of forming a coupling portion comprises the steps of disposing the intermediate product between the pair of heating/pinching elements during enlarging the slit, and coating the shield with a part of the external sheath, which part corresponds to a slit portion melted by simultaneously heating and pinching the intermediate product in a state in which a partitioning element for heating is disposed in the enlarged slit through a gap.

In the case of the machining apparatus and the manufacturing method of the present invention, when the coupling portion is formed, a face formed in the heating/pinching element, for enlarging the slit enlarges the slit in the intermediate product. Thus, a gap is formed between the partitioning element put into the slit and this face. Consequently, the intermediate product is pinched by the pinching face of the heating/pinching element and also heated. Thus, the external sheath melts and gets into the gaps formed at both sides of the partitioning element. As a result, the molten external sheath fill the gaps in a state in which the shield exposed in the slit is coated with the molten external sheath. Further, when the molten portion of the external sheath, which has got into the gaps, are harden, the coupling portion is formed. Practically, the heating/pinching element may be either a platen formed like a plate, or a pair of heating rollers. In either case, undulations formed on the coupling surface can constitute the pinching surface including the grooves that pinches the core wires and can constitute the face for enlarging the slit. Moreover, a heat source for the heating/pinching element may be an internal heater. Alternatively, the intermediate product may be externally heated.

Further, preferably, the pair of heating/pinching element is configured in such a manner as to be able to open and close between a semi-closed state, in which the branched terminal portion of the intermediate product can be introduced, and a pinched state in which the branched terminal portion can be pinched.

This facilitates the introduction of the intermediate product.

Moreover, preferably, the face for enlarging the slit is adapted to enlarge the slit by pushing the core wires of the branched terminal portion when the state of the pair of heating/pinching elements are changed from the semi-closed state to the pinched state.

This enables the enlargement of the slit without providing a special step for enlarging the slit. Therefore, the reliability of the slit enlarging operation is enhanced. Moreover, the operability is improved. The face for enlarging the slit is not limited to a flat one. A curved face may be used as the face for enlarging the slit.

In the shielded flat cable manufacturing method, preferably, the step of disposing the intermediate product between the pair of heating/pinching elements during enlarging the slit includes the steps of introducing a branched terminal portion of the intermediate product between the pair of heating/pinching elements that are preliminarily put in a semi-closed state, and thereafter closing the pair of heating/pinching elements.

This enables the supply of the intermediate product to the pair of heating/pinching elements.

According to another aspect of the present invention, there is provided a shielded flat cable manufacturing method having the steps of machining an intermediate product having a plurality of core wires arranged in parallel with one another on the same plane, a shield having a pair of metallic foils sandwiching each of the core wires in front and rear directions perpendicular to the plane and coating each of the core wires, an external sheath coating an outer circumference of the shield, and a slit formed in a layered product having the external sheath and the shield, the slit branching a terminal of each of the core wires, and forming a coupling portion maintaining the metallic foils of the shield in a coupled state, at a part where the slit is defined. This method comprises the steps of forming a through hole in the metallic foils sandwiching the core wires in the front and rear directions, thereafter forming the external sheath by molding, and subsequently forming the slit at a position through which the through hole passes.

According to this method of the present invention, only the addition of a step of punching or boring enables the external sheath to pass through the through hole formed in the shield. Further, the coupling portion for coupling the shield is formed without increasing the number of components. Moreover, the slit is formed at the position through which the through hole passes. Thus, the coupling portion is formed at a cut end of the branching slit. In the case of forming the slit by performing the branching step, the metallic foils are reliably maintained in the coupled state at the part at which the slit is formed.

In this manufacturing method, preferably, a plurality of through holes are formed along the core wires.

Thus, when the slit is formed, the length of the slit can be selected correspondingly to the plurality of through holes.

Furthermore, preferably, the through holes are formed in the bonded portion of the metallic foils, and thereafter a burr formed around each of the through holes is enlarged and deformed with respect thereto.

Additionally, it is preferable that terminal processing is performed on the core wires branched after the slit is formed.

Thus, the forming and machining of the slit can be performed simultaneously with the forming and machining of the slit for machining the terminal. Consequently, the number of the steps can be reduced.

Incidentally, in the description of the present specification, the “plurality of core wires” may be a group of electric wires including only coated wires (mainly, signal lines) electrically insulated from the shield. Alternatively, the “plurality of core wires” may be a group of electric wires including coated wires and drain wires that are electrically conducted to the shield. Furthermore, the “metallic foils” are not limited to genuine metallic foils. The “metallic foils” may include those, to which various kinds of coating for, for example, reinforcement.

### BRIEF DESCRIPTION OF THE DRAWINGS

FIG. 1 is a perspective view illustrating an example of a shielded flat cable according to the present invention.

FIG. 2 is a sectional view, which is taken on line A-A of FIG. 1 and which illustrates the shielding structure of the shielded flat cable.

FIG. 3 is a perspective view illustrating an example of the use of the shielded flat cable shown in FIG. 1.

FIG. 4 is a schematic view illustrating a process of manufacturing the shielded flat cable according to the present invention.

FIG. 5 is a schematic sectional view taken on line C-C of FIG. 4 illustrating the manufacturing process.

FIG. 6 is a schematic sectional view taken on line D-D of FIG. 4 illustrating the manufacturing process.

FIG. 7 is a perspective view illustrating a layered product manufactured by the manufacturing process illustrated in FIG. 4.

FIG. 8 is a perspective view illustrating the layered product manufactured by the manufacturing process illustrated in FIG. 4.

FIG. 9 is a perspective view illustrating a process of machining the layered product manufactured by the manufacturing process illustrated in FIG. 4.

FIG. 10 is a schematic perspective view illustrating another example of a coupling portion.

FIG. 11 is a schematic view illustrating another process of manufacturing the external sheath.

FIG. 12 is a schematic side view illustrating a machining apparatus that can be employed according to the present invention.

FIG. 13 is a perspective view illustrating a layered product machined by the manufacturing process illustrated in FIG. 12.

FIG. 14 is a perspective view illustrating a layered product machined by the manufacturing process illustrated in FIG. 12.

FIG. 15 is a schematic perspective view illustrating a machining apparatus according to another embodiment of the present invention.

FIG. 16 is a perspective view illustrating a primary part of the apparatus shown in FIG. 15.

FIG. 17 is a plan partial schematic view illustrating the primary part of the apparatus shown in FIG. 15.

FIG. 18 is a perspective view illustrating an intermediate manufacturing process of a shielded flat cable according to another embodiment of the present invention.

FIG. 19 is an enlarged front view of the primary part of the apparatus shown in FIG. 15.

FIG. 20 is an enlarged front view of the primary part shown in FIG. 15, which illustrates a machining process corresponding to FIG. 19.

FIG. 21 is a perspective view illustrating a shielding flat cable in which a coupling portion is formed by being heated and pinched.

FIG. 22 is a perspective view illustrating another machining apparatus to which the present invention can be applied.

FIG. 23 is an enlarged schematic plan view illustrating a primary part of the apparatus shown in FIG. 22.

FIG. 24 is a sectional perspective view illustrating a configuration of a conventional shielded flat cable.

FIG. 25 is a perspective view illustrating a state in which branching slits are formed in the shielded flat cable shown in FIG. 24.

### DETAILED DESCRIPTION OF THE EMBODIMENTS

Embodiments of the present invention are described hereinafter by referring to the accompanying drawings.

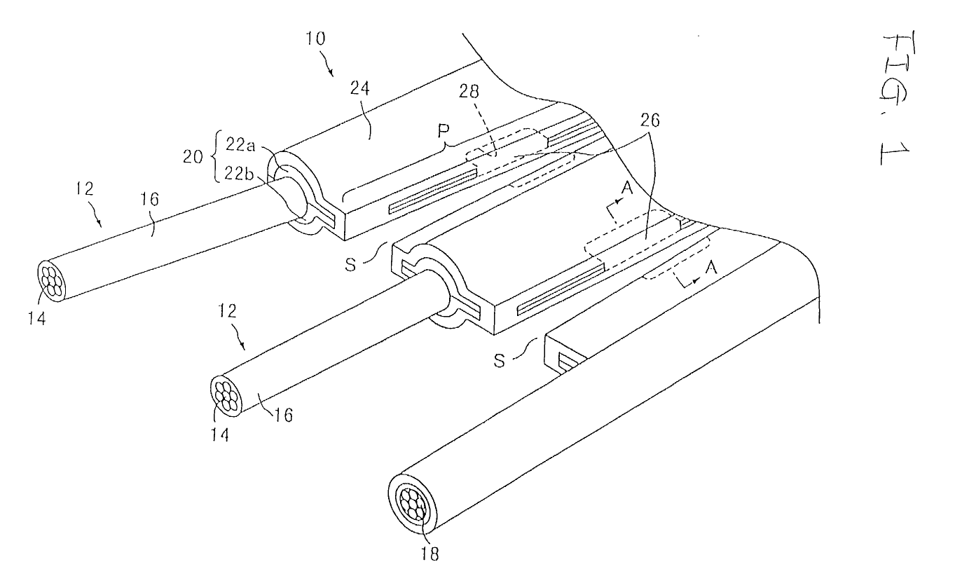

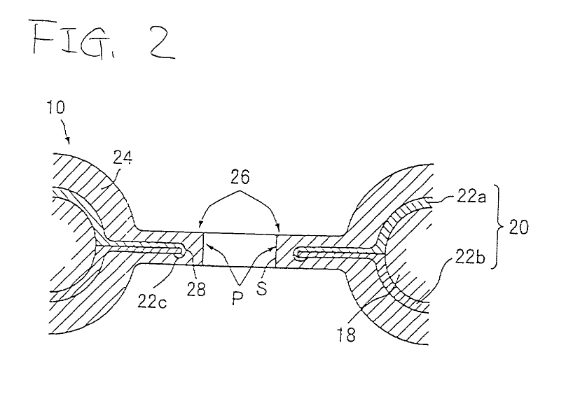

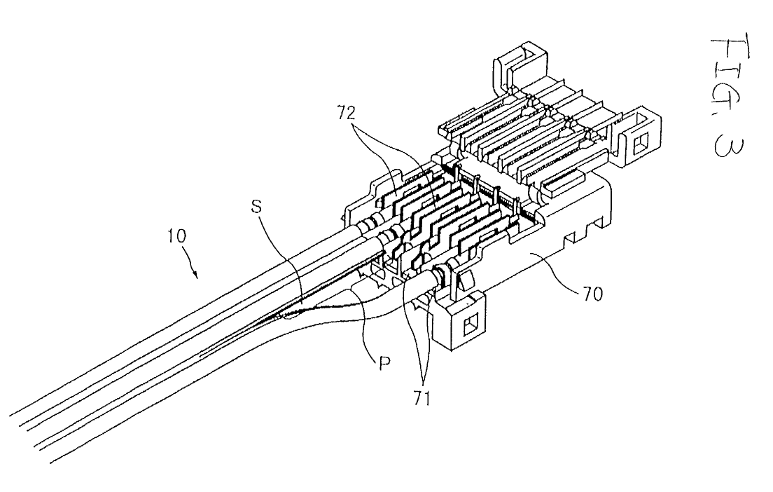

FIG. 1 is a perspective sectional view illustrating a shielded flat cable 110 according to the present invention. FIG. 2 is a sectional view taken on line A-A, which illustrates the shield structure of the shielded flat cable. Further, FIG. 3 is a perspective view illustrating an example of the use of the shielded flat cable 10 of FIG. 1. The shielded flat cable 10 illustrated in these figures has a plurality of coated wires 12, each of which is constituted by conductors 14 coated with an insulator 16, and drain wires 18 constituted only by conductors. These core wires (the coated wires 12 and the drain wires 18 in this embodiment) are arranged on the same plane in such a manner as to be in parallel with one another. The shield 20 and the external sheath 24 are formed therearound in such a manner as to be integrated therewith. In the case of the illustrated embodiment, peeling is performed on a terminal portion so that the shielded flat cable 10 is connected to a pressure terminal 72 accommodated in a pole 71 of a pressure connector 70 (see FIG. 3). Thus, the external sheath 24 and the shield 20 are cut off. Consequently, the insulator 16 is exposed from the terminal portion of the coated wire 12.

The shield 20 is formed by bonding a pair of electrically conductive metallic foils 22a and 22b together in such a way as to sandwich the core wires 12 and 18, as illustrated in FIG. 2. Incidentally, genuine metallic foils, such as copper foils, or metallic foils on each of which a reinforcement layer made of a resin is formed, are used as the metallic foils 22a and 22b.

A slit S is formed in a portion between the core lines 12 and 18, that is, a bonded portion at which the metallic foils 22a and 22b are bonded to each other. The slit S branches the terminal portion of each of the core wires 12 and 18. When the shielded flat cable 10 is connected to the pressure connector 70, and formed along the longitudinal direction of each of the core wires 12 and 18 so as to connect the individual wires 12 and 18 to the poles 71 provided at different intervals (see FIG. 3).

Several coupling portions 26 are formed at a part (that is, the cut end portion of the slit S) in which the slit S is defined. In the illustrated embodiment, the coupling portions 26 are configured so that through holes 28 are linearly formed in the bonded portion of the shield 20 at regular intervals, and that the peripheral edge portion of each of the through holes 28 is folded back to a rear side (a bottom surface side, as viewed in this figure) of the shield 20, more particularly, the peripheral edge portion 22c of the metallic foil 22a is folded back so that a corresponding part of the rear-side metallic foil 22b is supported and surrounded by a corresponding part of the front-side metallic foil 22a, and that the external sheath 24 penetrates through this through hole 28. That is, in the coupling portion 26, the metallic foils 22a and 22b are made by folding back the peripheral edge portion 22c to engage with each other. Furthermore, the metallic foils 22a and 22b are, as it were, rivet-fastened (riveted) to each other by the external sheath 24.

In the case of the aforementioned shielded flat cable 10, the coupling portion 26 is provided in the portion in which the slit S of the shield 20 is formed. Thus, as compared with the conventional shield structure in which the metallic foils are simply bonded with an adhesive, an extremely large coupling force acts between the metallic foils 22a and 22b. Thus, even in the case that the slit S is formed in the portion between the core wires 12 and 18, the metallic foils 22a and 22b do not easily peel off from each other. The shielding performance is effectively prevented from being degraded owing to the exfoliation of the metallic foils 22a and 22b.

Further, a plurality of coupling portions 26 are provided in the part in which the slit S is formed. Thus, the coupling force of the metallic foils 22a and 22b can be enhanced still more.

Moreover, in a state in which the metallic foils 22a and 22b are, as it were, riveted by the external sheath 24 as illustrated in FIG. 2, high strength can be obtained, in comparison with the structure in which the front side and the rear side of the external sheath 24 are stuck to each other in the through hole 28.

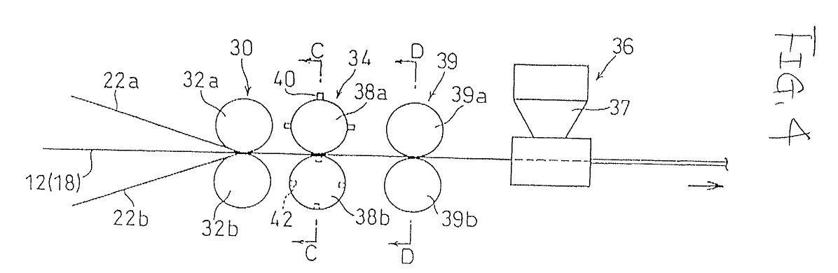

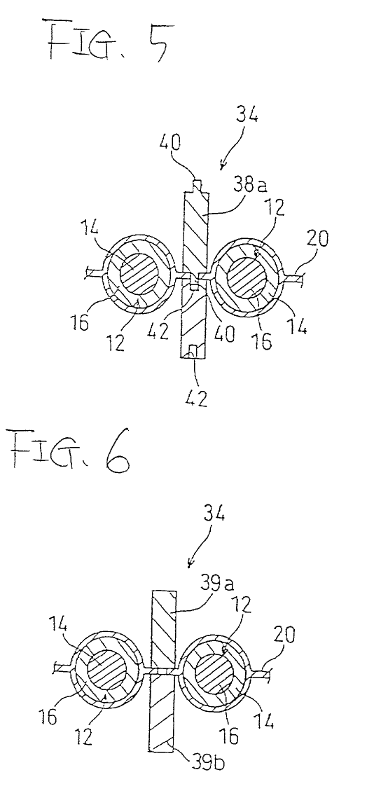

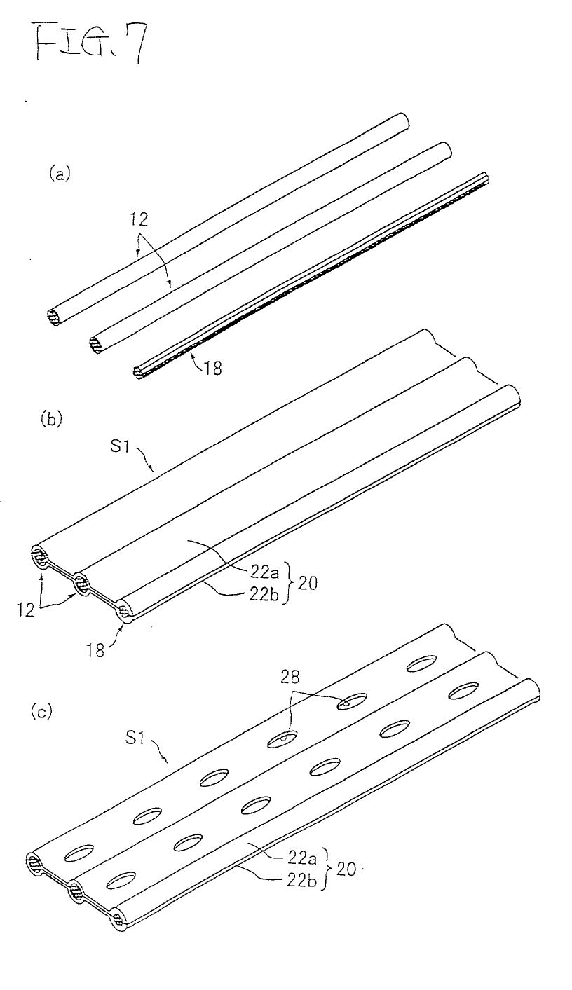

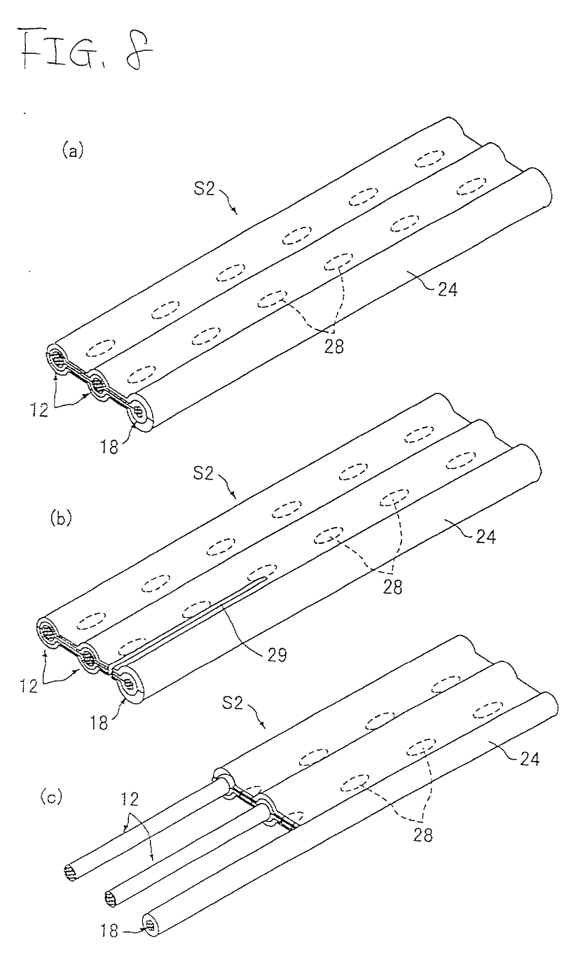

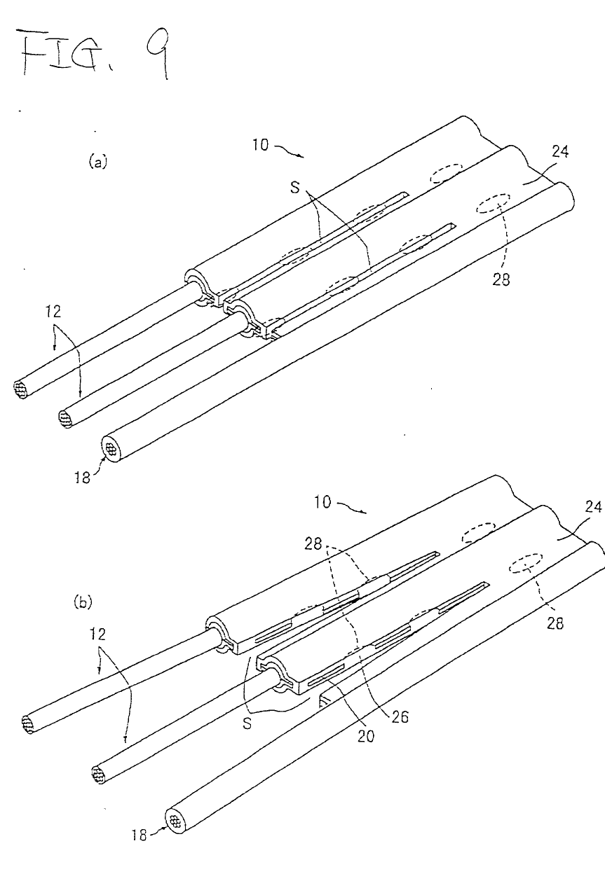

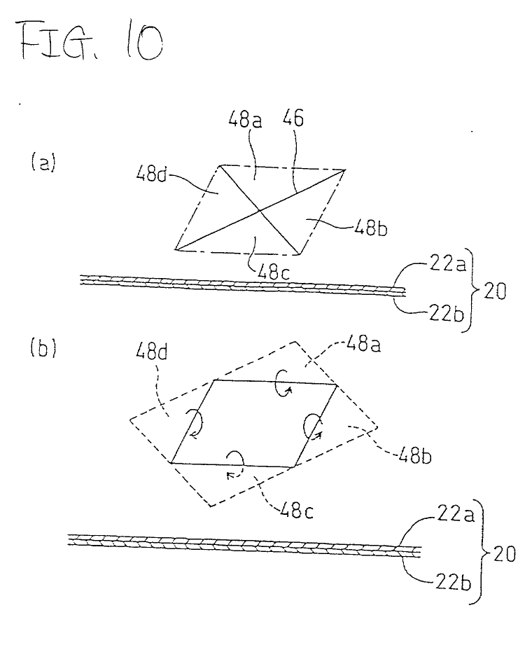

Next, a method of manufacturing the shielded flat cable 10 is described hereafter by referring to FIGS. 4 to 9. FIG. 4 is a schematic view illustrating an outline of a process of manufacturing the shielded flat cable 10. Further, FIG. 5 is a schematic sectional view taken on line C-C of FIG. 4. FIG. 6 is a schematic sectional view taken on line D-D of FIG. 4. Moreover, FIGS. 7 and 8 are perspective views of a layered product manufactured by the manufacturing process illustrated in FIG. 4. FIG. 9 is a perspective view illustrating a process of machining the layered product manufactured by the manufacturing process illustrated in FIG. 4.

Referring first to FIG. 4, the process of manufacturing the shielded flat cable 10 fundamentally comprises three steps, that is, a shield forming step 30, a punching step 34, and an external sheath forming step 36.

At the shield forming step 30, during the core wires 12 and 18 are drawn from reel members (not shown), around which the core wires 12 and 18 are wound, and a pair of metallic foils 22a and 22b are bonded to each other by an adhesive in such a manner as to sandwich these core wires 12 and 18. This operation is performed by letting the core wires 12 and 18 and the metallic foils 22a and 22b pass through between a pair of pressure rollers 32a and 32b and by integrally pressing such wires and foils. Thus, as illustrated in (a) of FIG. 7, the core wires 12 and 18 are introduced in between the pair of pressure rollers 32a and 32b in a state in which the core wires 12 and 18 are arranged in parallel with one another on the same plane (in a direction perpendicular to paper along a lateral direction as viewed in FIG. 4). Then, the core wires 12 and 18 are sandwiched between and coated with the metallic foils 22a and 22b in the front and rear directions (namely, upward and downward directions, as viewed in FIG. 4) perpendicular to the plane. Consequently, as illustrated in (b) of FIG. 7, the shield 20 is formed, and a flat layered product S1 is formed in such a way as to be integrated with the core wires 12 and 18.

At the punching step 34, the through hole 28 is formed in the bonded portion, in which the metallic foils 22a and 22b of the shield 20 are bonded to each other. This operation is performed by letting the layered product S1 pass through between a male roller 38a having projections 40 provided at uniform intervals on a circumferential surface thereof and a female roller 38b having recess portions 42 corresponding to the projections 40 provided on a circumferential surface thereof, and then causing each of the projections 40 to penetrate through the bonded portion, in which the metallic foils 22a and 22b are bonded to each other, as illustrated in FIGG. 5. Thus, as illustrated in (c) of FIG. 7, the through holes 28 are formed in the bonded portion of each of the metallic foils 22a and 22b of the shield 20 in such a manner as to be arranged in the longitudinal direction of the layered product S1. At that time, burrs (a peripheral edge portion 22c shown in FIG. 2) are formed on a peripheral edge portion of the through hole 28 in such a manner as to be directed in a direction from the front surface to the rear surface of the shield 20 (namely, in a downward direction, as viewed in FIG. 5).

In the case of the illustrated embodiment, the through hole 28 is shaped like an ellipse extending along the longitudinal direction of the core wires 12 and 18. Further, other shapes of the through hole may be, for instance, an oval and an ovoid. In either case, preferably, the through hole 28 is established in such a manner as to be as narrow as possible, so long as width of the through hole 28 is larger than that of the slit S, so as to maintain favorable electrical characteristics of the shield 20. Furthermore, it is preferable for enhancing sticking strength against the exfoliation at the part P, in which the slit S is formed, that the through hole 28 is as long as possible along the core wires 12 and 18.

Preferably, these through holes 28 are formed in a central portion between the adjacent core wires 12 and 18 in such a manner as to extend along the longitudinal direction of the core wires 12 and 18.

The layered product S1 having undergone the punching step 34 is caused to pass through between two rollers 39a and 39b provided for pressing down the burrs, as illustrated in FIG. 4. Thus, as illustrated in FIG. 6, the burrs are destructed by forcibly pressing down a part, whose thickness is increased due to the burrs, of the shield 20. At that time, a part of the burr formed around the through hole 28 is outwardly bent owing to the deformation of the burrs. Consequently, an engaging structure illustrated in FIG. 2 is formed.

At the external sheath forming step 36, the external sheath 24 is formed around the layered product SI by letting the layered product S1 pass through an extruding machine 37.

To put it concretely, the layered product is caused to pass through a cavity (that is, a mold path for forming the external sheath) formed in the extruding machine 37. Moreover, a sheath material, such as a thermoplastic material, is supplied to the cavity. Thus, the external sheath 24 is formed around the layered product by drawing the layered product therefrom while the sheath material is stuck to the periphery of the layered product. Then, when the sheath material is supplied to the cavity, the sheath material penetrates through the through hole 28. Thus, the shield 20 is rivet-fastened. Moreover, the coupling portion 26, which is operative to, as it were, rivet the shield 20 is formed. Furthermore, as illustrated in (a) of FIG. 8, another layered product S2 is formed in such a way as to coat the layered product S1 illustrated in FIG. 7(a) with the external sheath 24.

Subsequently, the peeling operation is performed so as to connect this layered product S2 to the pressure connector 70 (see FIG. 3). The peeling operation is conducted by forming a slit 29 in a portion between the core wires 12 and 18 along the longitudinal direction thereof, as illustrated in (b) of FIG. 8, and cutting off the external sheath 24 and the shield 20, which cover the terminal portions of the coated wires 12, from the end of this slit 29 along a direction perpendicular to the core wires 12 and 18.

Subsequently, the slit S for branching the terminal end portion of the shielded flat cable 10 are suitably selectively formed at a position, through which the through holes 28 pass, as illustrated in (a) and (b) of FIG. 9, so as to connect the core wires 12 and 18 correspondingly to the poles 71 of the crimping connector 70. The position and length of this slit S are changed depending on an object to which the shielded flat cable 10 is connected. However, in the illustrated embodiment, the coupling portions 26 are arranged at equal intervals along the longitudinal direction of the core wires 12 and 18. Consequently, the length and position of the slit S can be suitably changed. Moreover, the terminal portion can be branched for general purpose use.

Further, each of the core wires 12 and 18 can be connected to a corresponding one of the pressure terminals 72 accommodated in the poles 71 provided at different intervals, by providing the slits S.

According to the aforementioned method of manufacturing the shielded flat cable 10, the burrs formed in association with the formation of the through holes 28 are enlarged and deformed during the formation of the through holes 28 in the shield 20, so that the coupling portions 26 are formed. Therefore, the coupling portions 26 can easily be formed. Especially, the coupling portions 26 are formed at a stretch by undergoing a sequence of the steps, namely, the shield forming step 30, the punching step 34, the burr pressing-down step 39, and the external sheath forming step 36. Consequently, the shielded flat cables can be efficiently manufactured.

Incidentally, the aforementioned shielded flat cable 10 and the manufacturing method therefor are examples of the shielded flat cable, the manufacturing method, and the machining apparatus according to the present invention. The practical configuration of the shielded flat cable, and the practical manufacturing method therefor can be suitably changed without departing the scope of the invention.

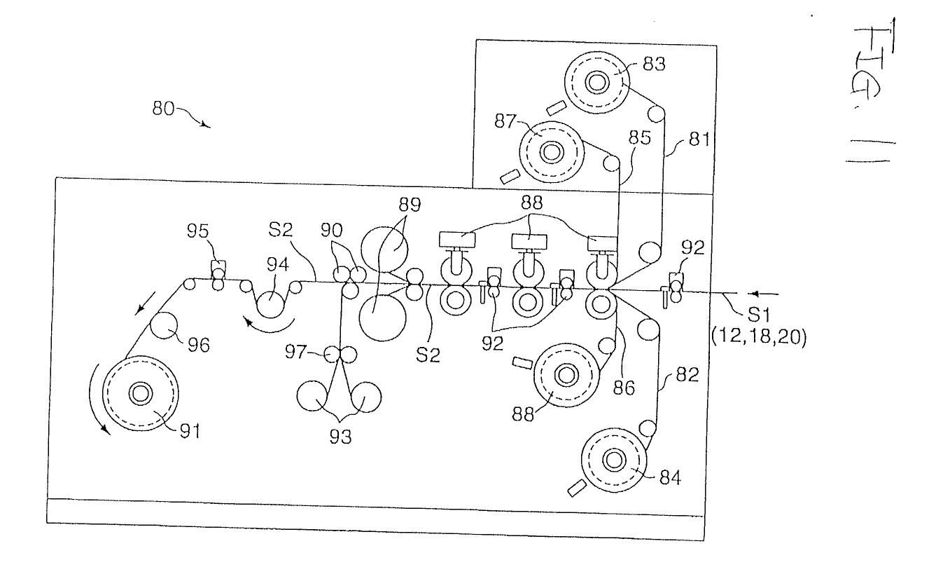

For example, in the shielded flat cable 10, circular through holes 28 are formed in the bonded portion, in which the metallic foils 22a and 22b of the shield 22 are formed. Then, the coupling portions 26 are formed by enlarging and deforming the burrs formed at that time. However, holes each having an elliptic or rectangular section may be formed and used. Further, for instance, as illustrated in (a) of FIG. 10, the coupling portions 26 may be formed by making a cruciform cut and folding back each of triangular portions 48a to 48d, whose oblique sides are the cut portions 46, to the rear side, as illustrated in (a) of FIG. 10, by using the corresponding base thereof as a fulcrum. In short, it is sufficient that the coupling portion 26 has a structure obtained by folding back a part of the bonded portion, in which the metallic foils 22a and 22b are bonded, so that one 22a or 22b of the metallic foils supports and surrounds the other metallic foil 22b or 22a. It is sufficient that the practical shape of the coupling portion 26 is suitably selected in such a manner as to effectively prevent the metallic foils 22a and 22b from peeling off from each other.

Incidentally, regarding the coupling portions 26, it is not always necessary to fold back the peripheral edge portion 22c of the through hole 28. Thus, the folding back of the portion 22c may be omitted. Further, regarding the construction of the shield 20, it is not always necessary to bond the metallic foils 22a and 22b by an adhesive. Thus, the bonding thereof using the adhesive may be omitted. In short, only in the case that the peeling of the metallic foils 22a and 22b cannot be sufficiently prevented by forming the external sheath according to the use and usage conditions of the shielded flat cable 10 in such a manner as to penetrate the bonded portion, in which the metallic foils 22a and 22b are bonded to each other, the coupling force of the metallic foils 22a and 22b may be enhanced by employing the configuration obtained by folding back the peripheral edge portion of the through hole 28.

Furthermore, at the step of forming the external sheath 24, a laminating method may be employed in addition to the aforementioned molding method.

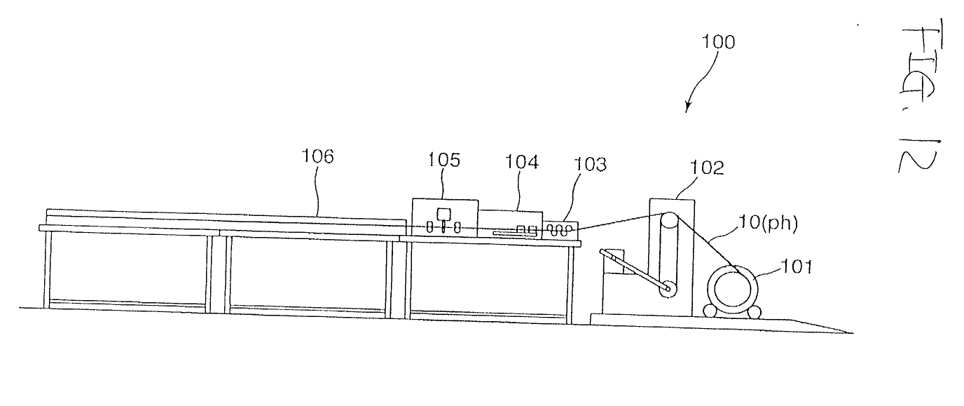

FIG. 11 is a schematic view illustrating another process of manufacturing the external sheath 24.

In the case of the method illustrated in this figure, the external sheath 24 is formed from a pair of insulative tapes 81 and 82 by using a laminator 80.

The laminator illustrated in FIG. 11 comprises supply reels 83 and 84 for supplying insulative tapes 81 and 82 stuck onto both sides of the punched layered product SI, release tape reels 87 and 88 for supplying release tapes 85 and 86 to the rear sides of the supplied insulative tapes 81 and 82, three pairs of heating rollers 88 for putting the insulative tapes 81 and 82 and the release tapes 85 and 86 onto both the top and rear sides of the layered product S1 in this order and for heating the tapes, a take-up device 89 for taking up the release tapes 85 and 86 after heated, a slitter 90 for uniformly cutting both sides of the layered product S2 formed by the pairs of heating rollers 88, and a take-up device 91 for taking up the layered product S2, on which the external sheath 24 is formed by being cut by the slitter 90. Incidentally, a pair of guide rollers 92 is disposed at an appropriate place on a conveying path for conveying the layered product S1 and the layered products S2. Furthermore, a take-up portion 93 for taking up cut chips is provided at the downstream side of the slitter 90. A take-off capstan 94 is disposed between the take-up device 91 and the slitter 90. Furthermore, reference numeral 95 designates a starting chip pinch roller, and reference numeral 96 denotes a traverse roller, and reference numeral 97 designates a pinch roller.

According to this apparatus, the insulative tapes 81 and 82 are stacked on both sides of the layered product S1 in which the wires 12 and 18 are coated with the shield 20. Then, these tapes and the product are laminated by the pair of heating rollers 88. Thereafter, the product is cut by the slitter 90 to a predetermined constant width. Thus, the layered product S2 is formed, and taken up by the take-up device 91.

Next, a slit forming step and a peeling step performed by another embodiment of the present invention are described hereafter by referring to FIG. 12 and the following figures. FIG. 12 is a schematic side view illustrating a machining apparatus that can be employed according to the present invention. Furthermore, FIGS. 13 and 14 are perspective views illustrating the layered product machined in the manufacturing process illustrated in FIG. 12.

An apparatus 100 illustrated in FIG. 12 has a cable feeding reel 101, an accumulator 102, a straightener 103, a slitter 104, and a sizing cutter 105, which are arranged on a predetermined conveying path ph in this order from the upstream side thereof. Further, a shielded flat cable 10 wound around the cable feeding reel 101 is supplied through the accumulator 102 to the straightener 103. Then, in a state in which the curl of the cable is eliminated, the slits S are formed in the terminal portion of the cable by the slitter 104 (see (b) of FIG. 13). Furthermore, the total length of the cable is adjusted by the sizing cutter 105. The terminal portion of the external sheath 24 is cut in a state, in which the coated wires 12 are partly removed, to the desired length. Thus, the shielded flat cable 10 illustrated in (a) of FIG. 14 is completed.

A collector 106 is disposed at the downstream side of the sizing cutter 105. The sized and cut shield flat cable 10 is conveyed and collected by a conveyer (not shown) of this collector 106.

Referring next to FIG. 14, the terminal portion of the shielded flat cable 10 manufactured as described above is moved according to the postprocessing step, that is, for example, is subjected directly to a pressure welding step, as illustrated in (a) of FIG. 14, alternatively, subjected to a crimping step through a peeling step of peeling the coated wires 12 and the terminal portion of the external sheath 24 of the drain line 18, as illustrated in (b) of FIG. 14.

Meanwhile, although the punching of the shield 20 is indispensable for the aforementioned embodiment, the present invention is not limited to such an embodiment. The coupling portion can be formed by using a machining apparatus 120 illustrated in FIG. 15 without punching.

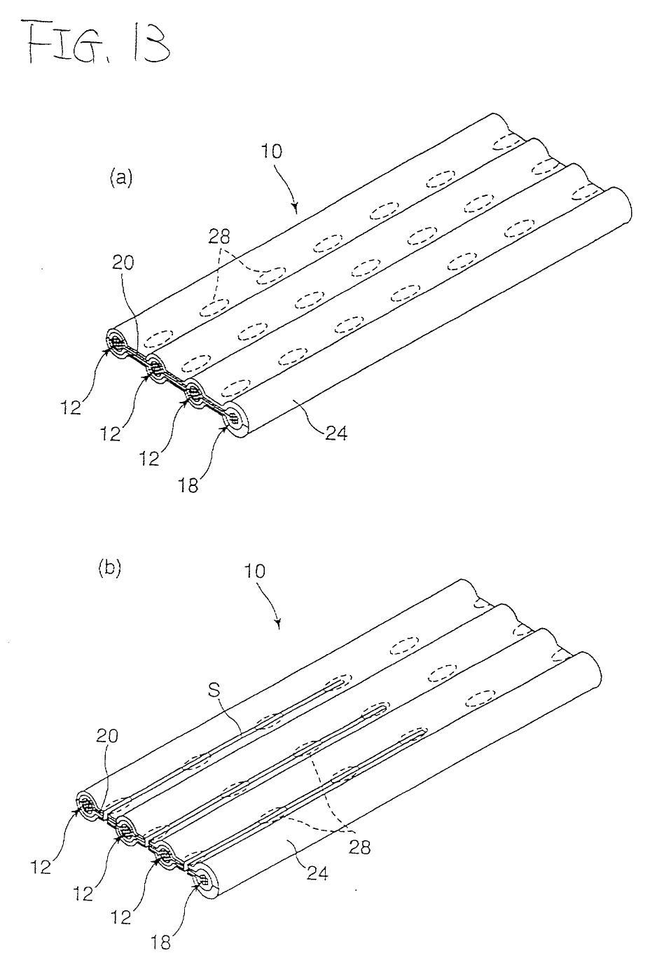

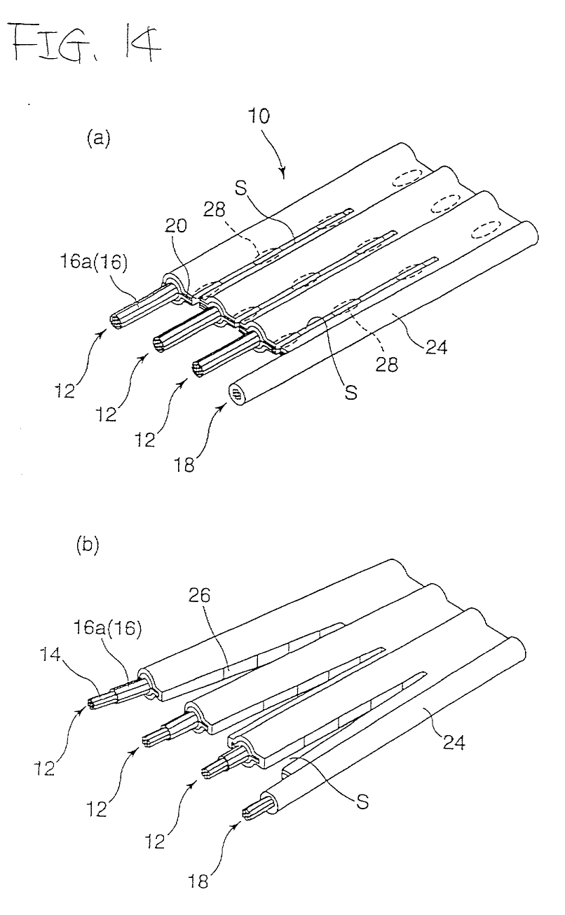

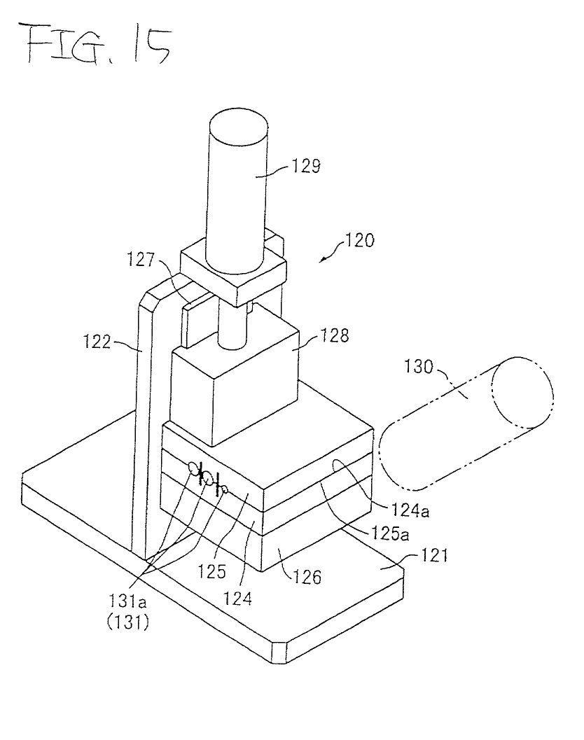

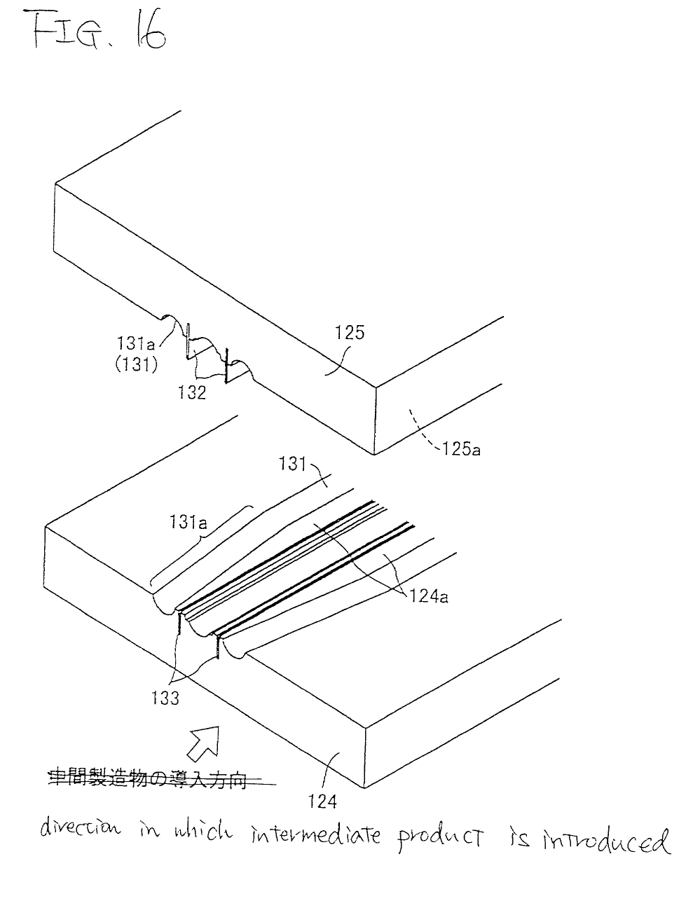

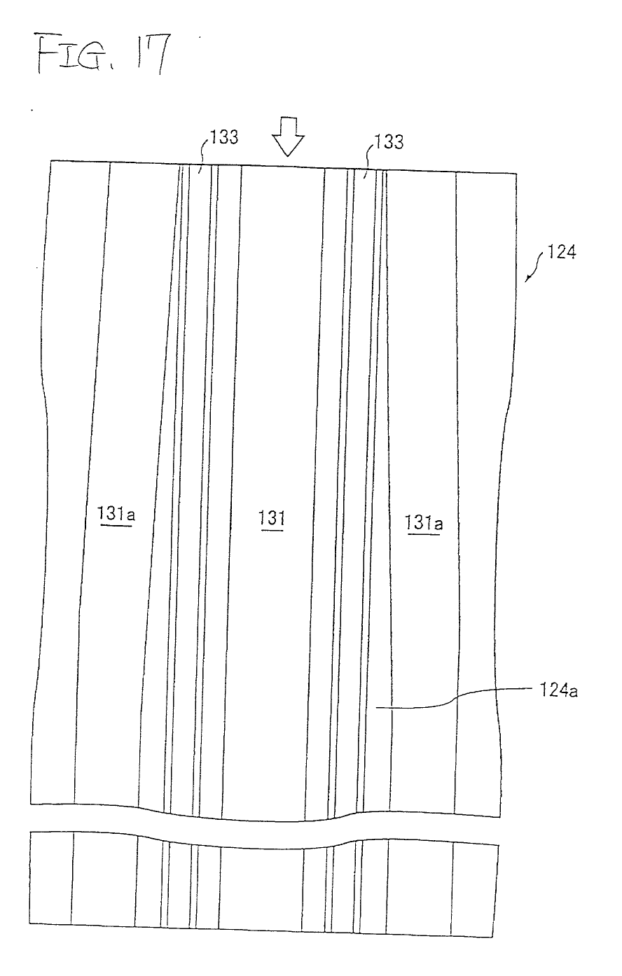

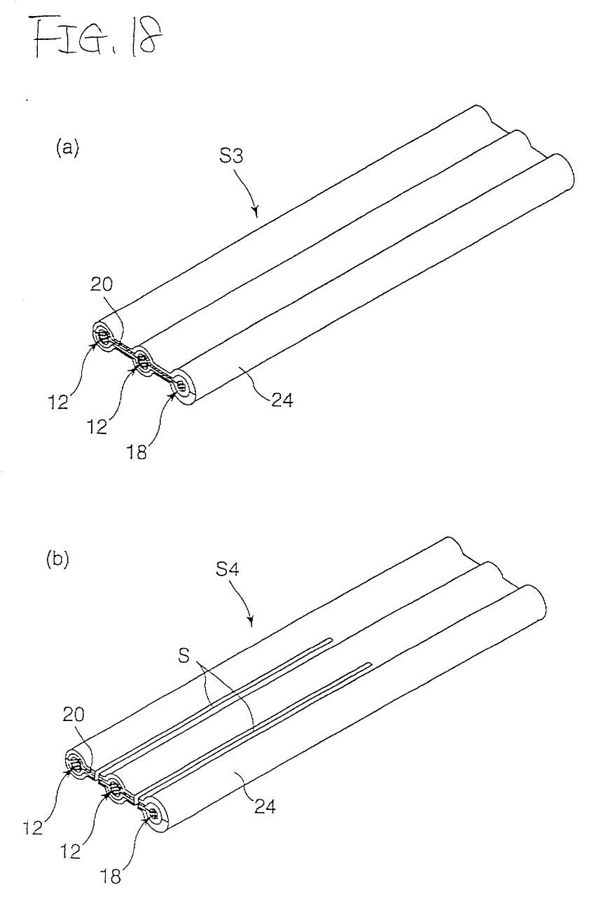

FIG. 15 is a schematic perspective view of the machining apparatus 120 according to the another embodiment of the present invention. FIG. 16 is a perspective view illustrating a primary part of the apparatus shown in FIG. 15. FIG. 17 is a schematic partial plan view of the primary part of FIG. 15. Further, FIG. 18 is a perspective view illustrating an intermediate manufacturing process of a shielded flat cable 10 according to this embodiment.

Referring first to FIG. 15, the machining apparatus 120 illustrated in this figure has a base 121, a mounting plate 122 erected on a middle portion of the base 121, a lower platen 124 carried by the mounting plate 122, and an upper platen 125 disposed on the lower platen 124. This apparatus is adapted to melt a part of the external sheath 24 and to form the coupling portion 26 by pinching an intermediate product S4 (see (b) of FIG. 18) by using both the platens 124 and 125 (an example of the heating/pinching element) in a heated state (about at 130° C. to 160° C.). Blowers 130 for industrial use may be used as means for heating the platens 124 and 125.

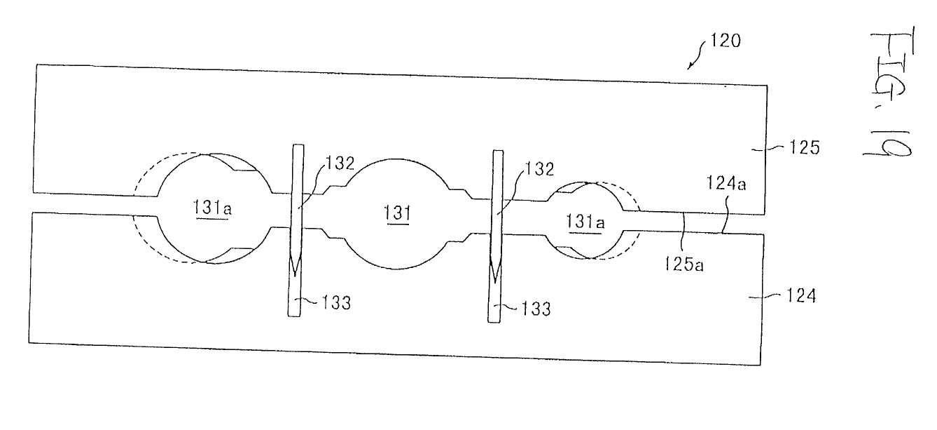

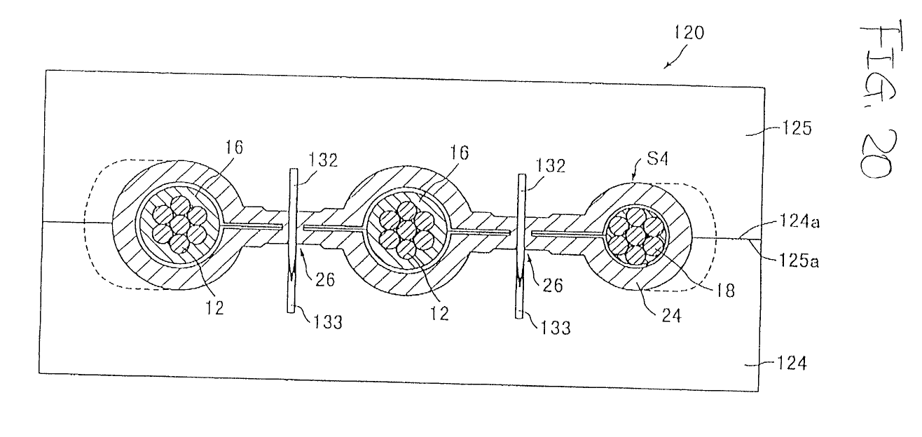

The lower platen 124 is fixed to the mounting plate 122 through a platen base 126. The upper platen 125 is a movable member connected to a block 128, which is guided by an LM guide 127 in such a manner as to be moved upwardly and downwardly by a drive member (for example, an air cylinder) 129 adapted to lift and lower this block 128. Lifting and lowering operations of this upper platen 125 can be controlled in such a manner as to be put in an opened state illustrated in FIG. 16, and brought by an operating means (for instance, a foot switch) connected to a control unit (not shown) in a partly fitted state, which is illustrated in FIG. 19, and a fitted state, which is illustrated in FIG. 20.

Referring now to FIGS. 16 and 17, the opposed surfaces of the platens 124 and 125 compose pinching surfaces 124a and 125a, (to be described later) for pinching the intermediate product S4 (see (b) of FIG. 18). Introducing grooves 131 for introducing the core wires 12 and 18 of the intermediate product S4, on which the slits are formed, are formed in the pinching surfaces 124a and 125a. In the illustrated embodiment, the introducing grooves 131 correspond to two coated wires 12, 12 and one drain line 18. The introducing groove 131 corresponding to the drain wire 18 (in FIG. 19, the rightmost one) is set so that the diameter thereof is smaller than the diameters of the other introducing grooves. Incidentally, in the case of the illustrated embodiment, a shielded flat cable 10 having three core wires 12 and 18 is manufactured. However, as exaggeratingly illustrated in FIG. 16, both the side introducing grooves 131 have inclined portions 131a (namely, examples of a face for enlarging the slit S) formed so that the downstream-side parts thereof are inclined in directions in such a way as to be increasingly away from each other. These inclined portions 131a act with the central introducing groove 131 in such a way as to enlarge each of the slits S formed in the intermediate product S4 introduced to the apparatus.

A Blade 132 serving as a partitioning element is provided between each pair of adjacent ones of the introducing grooves 131, 131. In the lower platen 124, a slit 133 facing this blade 132 is provided.

When the machining apparatus 120 is employed, the coupling portions 26 can be formed by performing the following procedure without punching.

That is, the layered product S1, on which punching is not performed, is supplied to the apparatus disclosed in FIG. 11. Then, the layered product S3 having the external sheath is manufactured on the product S1 (see (a) of FIG. 18). Subsequently, the intermediate product S4, in which the slits are formed, are manufactured (see (b) of FIG. 18).

FIG. 19 is an enlarged schematic front view of a primary part of FIG. 15. FIG. 20 is an enlarged schematic front view of the primary part, which illustrates the machining process corresponding to FIG. 19.

After the intermediate product S4 is manufactured, the platens 124 and 125 of the machining apparatus 120 are brought into a partly fitted state, as illustrated in FIG. 19. Then, the branch terminals of the intermediate product S4 are introduced into the introducing grooves 131, respectively. In this partly fitted state, during the blade 132 is put into the slit 133, the upper platen 125 faces and is slightly floated above the lower platen 124 (by, for example, 0.5 mm). When the branch terminals, that is, the core wires 12 and 18 of the intermediate product S4 are introduced to the introducing grooves 31 in the partly fitted state, the core wires 12 and 18 are pushed into the grooves 131 by the inclined portions formed in the side introducing grooves 131 so that the distance between the ends of the adjacent core wires 12 and 18 is broaden toward the inner end of the slits S. Therefore, at this stage, a gap, into which the molten part of the external sheath 24 flows, is formed between the wall surface of the slit S and the blade 132 (see FIG. 20).

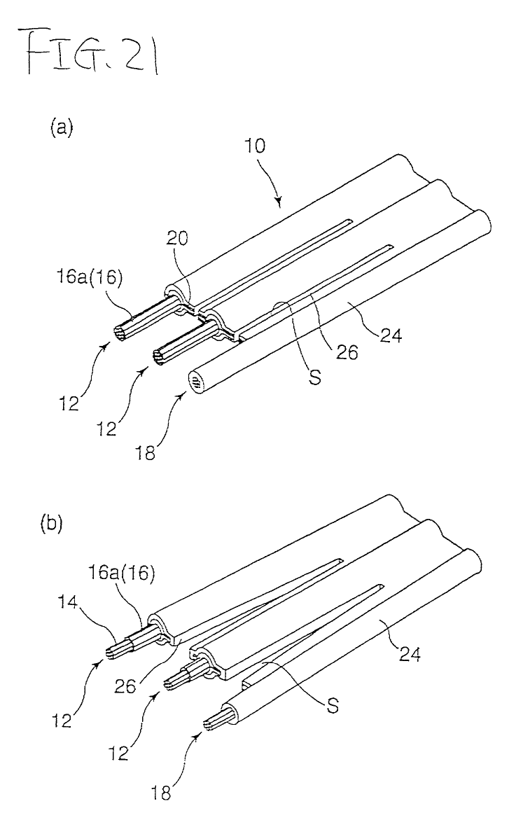

In this state, the upper platen 125 is caused to descend, so that a mold is clamped. Then, the intermediate product S4 is heated while pinched. Thus, as illustrated in FIG. 20, the molten part of the external sheath 24 flows into both side portions of the blade 132. Then, the shield 20 exposed in the slit S at the time of forming the slit S is coated with the molten part. Thereafter, the upper platen 125 is lifted, so that both the platens 124 and 125 are opened, and a work is taken out thereof and cooled. Thus, the shielded flat cable, in which the slit S is continuously sealed with the external sheath 24 along the longitudinal direction thereof, can be obtained (see (a) of FIG. 21).

FIG. 21 is a perspective view of the shielded flat cable 10 in which the coupling portion is formed by heating and pinching. As illustrated in (a) of FIG. 21, the coupling portion 26 is formed along the longitudinal direction of the slit S by performing the aforementioned process. The shield 20 exposed in the slit S in the intermediate manufacturing process is almost completely covered with this coupling portion 26. Further, after this coupling portion 26 is formed, the peeling is performed thereon, similarly as in the case illustrated in FIG. 14. This enables the formation of the branch portion that can be connected to a pressure terminal (see (b) of FIG. 21). Needless to say, when this cable is applied to the pressure contact terminal, this peeling can be omitted.

In the case of forming the coupling portion 26 by using the machining apparatus of FIG. 15, the need for punching is eliminated. Moreover, in such a case, the coupling portion 26, which continuously covers the shield 20 in the longitudinal direction of the slit S, can be formed. Thus, the necessity for pressing down the burrs can be eliminated. This is advantageous in machining the flat cable.

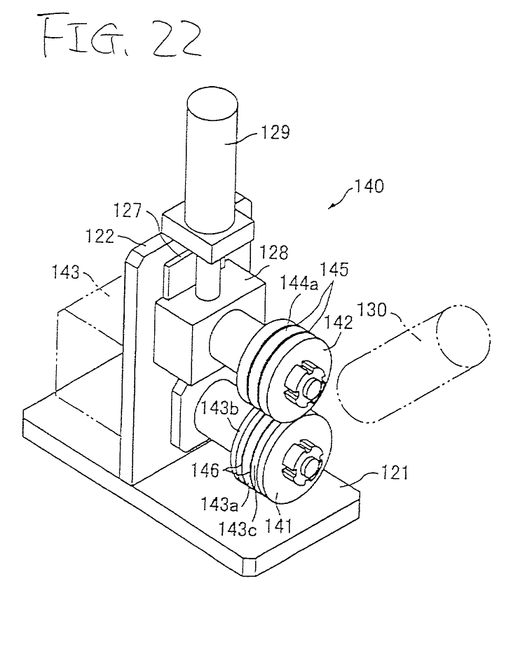

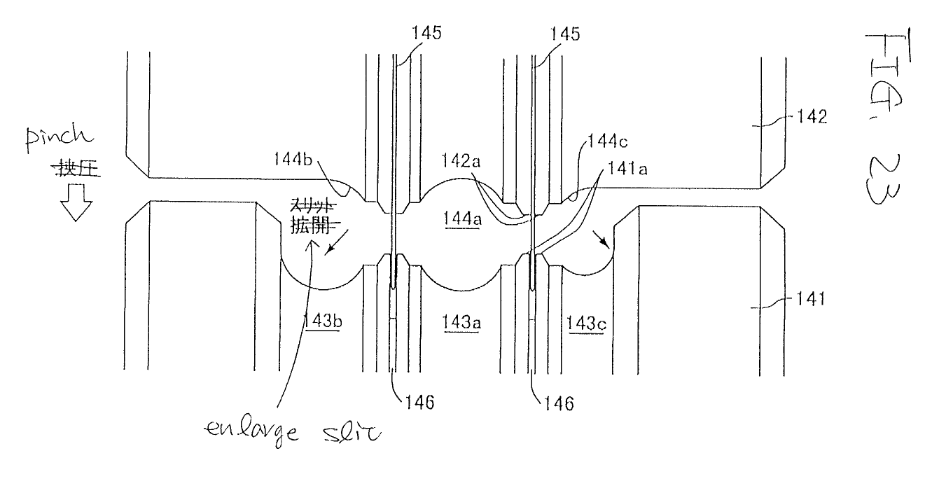

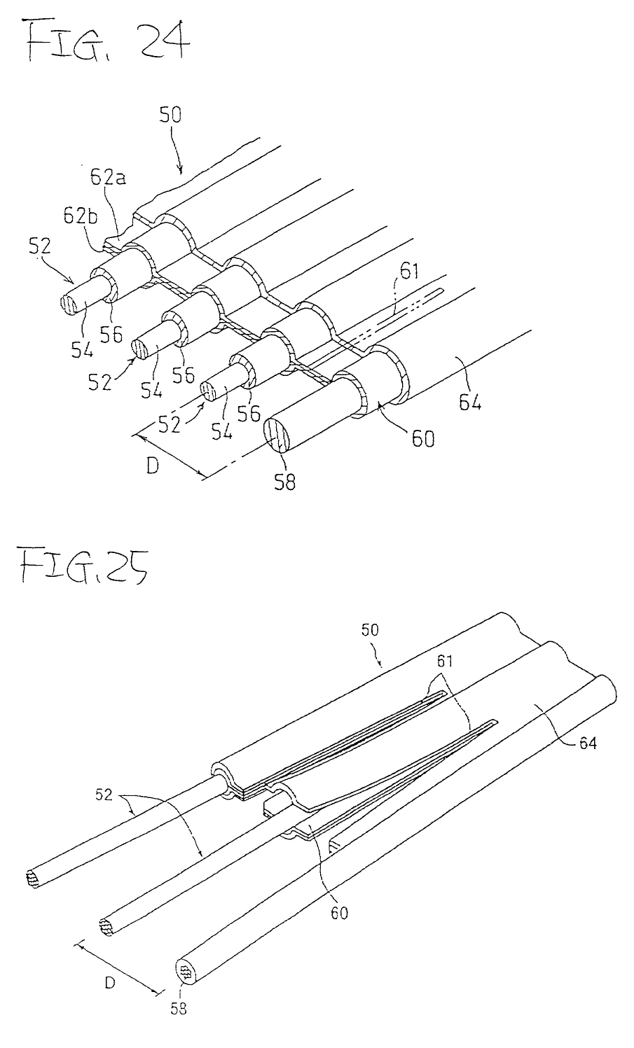

A machining apparatus (or method) 140 illustrated in FIGS. 22 and 23 may be employed as the apparatus (or method) for forming the coupling portion by heating and melting the external sheath 24 without punching.

FIG. 22 is a perspective view illustrating another machining apparatus 140 to which the present invention can be applied. FIG. 23 is a schematic front view of the primary part shown in FIG. 22. Incidentally, in FIG. 22, like or corresponding parts are designated by the same reference characters denoting like or corresponding parts illustrated in FIG. 15. Thus, the description of such parts is omitted herein.

As illustrated in FIG. 22, the machining apparatus 140 has a pair of heating rollers 141 and 142 (each of which is another example of the heating/pinching element). The heating rollers 141 and 142 are provided in such a manner as to face each other in the upward or downward directions, and constitute nip rollers (see FIG. 23) The lower heating rollers 141 are rotated and driven by being connected to the drive unit 143. The upper heating roller 142 is a driven roller rotatably attached to a block 128 and upwardly and downwardly movably held by a drive member 129 for lifting and lowering the block 128.

Referring to FIG. 23, the circumferential surfaces of the heating rollers 141 and 142 constitute pinching surfaces 141a and 142a for pinching the intermediate product S4.

Three introducing grooves 143a to 143c for introducing the terminal portion of the intermediate product S4 are formed in the lower heating roller 141 correspondingly to the core wires 12 and 18 of the intermediate product S4 to be machined. Each of the introducing grooves 143a to 143c is implemented by circumferential grooves formed in the pinching surface 141a of the heating roller 141. On the other hand, a circumferential groove 144a, which faces the central introducing groove 143a, and nearly tapered pinching curved surfaces (namely, inclined surfaces) 144b and 144c, which face both the side introducing grooves 143b and 143c) are formed in the upper heating roller 142. Further, in the illustrated embodiment, when the intermediate product S4 is pinched, both the side core wires 12 and 18 are taken away from the central core wire 12 by the arcuate shapes of the pinching curved surfaces 144b and 144c (each of which is another example of the face for enlarging the slit S) formed on both sides thereof, so that each of the slits S can be enlarged. Further, a pair of ring-like blades 145 are fixed at a part, which faces the slit S of the intermediate product S4, of the upper heating roller 142. Moreover, the ring-like groove 146 for setting the corresponding ring-like blade therein is formed in the lower heating roller 141.

With the aforementioned configuration, the branch terminal of the intermediate product S4 is introduced into between the nip rollers put in the partly fitted state illustrated in FIG. 23, after the intermediate product S4 (see (b) of FIG. 18) is preliminarily manufactured. Then, the upper heating roller 142 is lowered. Thus, the intermediate product S4 is pinched during heated, so that the slit S formed in the bonded portion between the core wires 12 and 18 is enlarged. Then, the upper heating roller 142 is lowered, and the mold is clamped. The intermediate product S4 is heated by being simultaneously pinched. Consequently, a shielded flat cable 10, in which the slit portion S is continuously sealed with the external sheath 24 along the longitudinal direction of the slit portion S, can be obtained (see (a) of FIG. 21), similarly as in the case of the embodiment illustrated in FIG. 15.

Furthermore, if possible, the burr pressing-down step 39 (see FIG. 4) may be omitted from the process of manufacturing the shielded flat cable 10. That is, when the external sheath is formed, burrs formed on the peripheral portion of each of the through holes 28 can be pressed down by the material of the sheath and enlarged and deformed by the pressure of this material in the case of some shape of the cavity in the extruding machine 37 and some position at which the material of the sheath is introduced. Thus, the coupling portion 26 can be formed. Therefore, in such a case, when the external sheath 24 is formed, the coupling portion 26 is formed together with the sheath by omitting the burr pressing-down step 39. Consequently, the coupling portion 26 can be efficiently formed.

Meanwhile, in the shielded flat cable 10, the metallic foils 22a and 22b are first bonded to each other. Then, the coupling portion 26 is formed in the bonded portion in which these foils are bonded. However, the coupling portion may be configured by performing spot welding on the bonded portion, instead of forming the through hole 28. In such a structure of the shield 20, the coupling force of the metallic foils 22a and 22b having the slit S can be effectively enhanced, similarly as in the case of the shielded flat cable 10. Even in the case that the slit is formed between the core wires, the metallic foils can be effectively prevented from peeling off from each other. Incidentally, in the case of this structure, it is not always necessary to bond the metallic foils 22a and 22b by an adhesive. Therefore, the bonding of the metallic foils by the adhesive may be omitted.

Further, the shielded flat cable 10 can be applied not only to the pressure connector but also to the pressure connector having a pressure contact terminal.

As described above, according to the present invention, there is provided a shielded flat cable, which can prevent the metallic foils from peeling from each other even when the slit is formed between the core wires, and which also can effectively prevent the shielding performance thereof from being degraded owing to the exfoliation of the metallic foils.

What is claimed is:

1. A shielded flat cable comprising:
a plurality of core wires arranged in parallel with one another on the same plane;
a shield including a pair of metallic foils sandwiching each of the core wires in front and rear directions perpendicular to the plane;
an external sheath adapted to coat an outer circumference of the shield;
a slit selectively formed between the core wires to branch a terminal of each of the core wires; and
a coupling portion formed at least at a part defining the slit to maintain both the metallic foils of the shield in a coupled state.

2. The shielded flat cable according to claim 1, wherein the coupling portion comprises a plurality of the coupling portions formed in a longitudinal direction of the slit.

3. The shielded flat cable according to claim 1, wherein the coupling portion is constructed by welding the metallic foils of the shield.

4. The shielded flat cable according to claim 1, further comprising a through hole formed at a bonded portion of the metallic foils of the shield, wherein the coupling portion connects a front and rear side of the external sheath to each other through the through hole.

5. The shielded flat cable according to claim 4, wherein the external sheath is made of resin molded on an outer periphery of the shield to fill the through hole.

6. The shielded flat cable according to claim 4, wherein one of the metallic foils of the shield is folded back to be supported and surrounded by the other of the metallic foils of the shield at a peripheral edge portion of the through hole.

7. The shielded flat cable according to claim 4, wherein the metallic foils of the shield are stuck to each other.

8. The shielded flat cable according to claim 4, wherein the through hole is formed in a longitudinal direction of the slit.

9. The shielded flat cable according to claim 1, wherein the coupling portion continuously extends in a longitudinal direction of the slit.

10. The shielded flat cable according to claim 9, wherein the coupling portion is continuously formed at a part of the external sheath.

11. A shielded flat cable machining apparatus adapted to machine an intermediate product having a plurality of core wires arranged in parallel with one another on the same plane, a shield having a pair of metallic foils sandwiching each of the core wires in front and rear directions perpendicular to the plane and coating each of said core wires, an external sheath adapted to coat an outer circumference of the shield, and a slit formed in a layered product having the external sheath and the shield, the slit branching a terminal of each of the core wires, the shielded flat cable machining apparatus adapted to form a coupling portion maintaining the metallic foils of the shield in a coupled state, at a part where the slit is defined, the shield flat cable machining apparatus comprising:
a pair of heating/pinching elements adapted to pinch a branched terminal portion of the intermediate product and to melt a portion where the slit is formed;
a pair of pinching surfaces each formed on the heating/pinching elements and defining a plurality of grooves corresponding to the core wires included in the branched terminal portion; and
a pair of partitioning elements each disposed between adjacent ones of the plurality of grooves to be put into the slit when the branched terminal portion is pinched,
wherein a face adapted to enlarge the slit is formed in each of the grooves so that a gap is formed between a corresponding one of the core wires and a corresponding one of the partitioning elements when the intermediate product is pinched.

12. The shielded flat cable machining apparatus according to claim 11, wherein the pair of heating/pinching elements are configured to be able to open or close between a semi-closed state in which the branched terminal portion of the intermediate product is introduced, and a pinched state in which the branched terminal portion is pinched.

13. The shielded flat cable machining apparatus according to claim 12, wherein the face enlarges the slit by pushing the core wires of the branched terminal portion when a state of the pair of heating/pinching elements are changed from the semi-closed state to the pinched state.

14. A shielded flat cable manufacturing method comprising the steps of:
machining an intermediate product having a plurality of core wires arranged in parallel with one another on the same plane, a shield having a pair of metallic foils sandwiching each of the core wires in front and rear directions perpendicular to the plane and coating each of the core wires, an external sheath adapted to coat an outer circumference of the shield, and a slit formed in a layered product having the external sheath and the shield, the slit branching a terminal of each of the core wires; and
forming a coupling portion at a part where the slit is defined, to maintain the metallic foils of the shield in a coupled state, wherein the coupling portion forming step comprises the steps of:
disposing the intermediate product between a pair of heating/pinching elements during enlarging the slit; and
coating the shield with a part of the external sheath, which part corresponds to a slit portion melted by simultaneously heating and pinching the intermediate product in a state in which a partitioning element for heating is disposed in the enlarged slit through a gap.

15. The shielded flat cable manufacturing method according to claim 14, wherein the disposing step includes the steps of:
introducing a branched terminal portion of the intermediate product between the pair of heating/pinching elements that are preliminarily put in a semi-closed state; and
closing the pair of heating/pinching elements.

16. A shielded flat cable having an intermediate product having a plurality of core wires arranged in parallel with one another on the same plane, a shield having a pair of metallic foils sandwiching each of the core wires in front and rear directions perpendicular to the plane and coating each of the core wires, an external sheath adapted to coat an outer circumference of the shield, and a slit formed in the external sheath and a layered product having the external sheath and the shield, the slit branching a terminal of each of the core wires, the shielded flat cable manufacturing method comprising the steps of:
forming a through hole in the metallic foils;
forming the external sheath by molding; and
forming the slit at a position through which the through hole passes.

17. The shielded flat cable manufacturing method according to claim 16, wherein the through hole forming step forms a plurality of the through holes along the core wires.

18. The shielded flat cable manufacturing method according to claim 16, further comprising the steps of:
forming the through holes at a bonded portion of the metallic foils to form a burr around each of the through holes,
enlarging and deforming the burr with respect to the through holes.

19. The shielded flat cable manufacturing method according to claim 14, further comprising the step of performing terminal processing on the core wires branched after the slit is formed.

20. The shielded flat cable manufacturing method according to claim 16, further comprising the step of performing terminal processing on the core wires branched after the slit is formed.
